(19) United States
(12) Patent Application Publication
(10) Pub. No.: US 2003/0014761 A1
(43) Pub. Date: Jan. 16, 2003

(54) System and method for retrieving information by one click using caption information

(75) Inventor: Goo Jun, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/101,738

(22) Filed: Mar. 21, 2002

(30) Foreign Application Priority Data
Jul. 13, 2001 (KR) 2001-42491

(51) Int. Cl. G09G 5/00; H04N 7/173

(52) U.S. Cl. 725/109; 345/738

(57) ABSTRACT

A system for retrieving information by one click using caption information having a broadcasting signal receiving portion for receiving a broadcasting signal including caption information, a caption information storing portion for storing the received caption information, a sentence analyzing portion for separating a main word from the stored caption information, an Internet retrieving portion for performing an Internet retrieving operation using at least one word of the caption information, a displaying portion for displaying a retrieved result of the Internet retrieving portion on a screen on which the broadcasting signal is displayed, an input portion for inputting an instruction for displaying the retrieved result, and a retrieved result storing portion for storing the retrieved result. If the user inputs the information retrieving instruction through the input portion, the information retrieving operation for the caption information is performed at the same time as the user is viewing.

### BACKGROUND OF THE INVENTION

1. Field of the Invention

The present invention relates to a system for retrieving information using caption information, and more particularly, to a system for retrieving information using caption information, in which information of a corresponding word is retrieved from the caption information using a web browser when receiving a caption broadcast through an Internet TV. The present application is based on Korean Application No. 2001-42491, filed on Jul. 13, 2001, which is incorporated herein by reference.

2. Description of the Related Art

Generally, a caption broadcasting system in television broadcasting can be classified into an open caption system for displaying a caption of emergency news, announcements, etc., on a television screen by selection of a broadcaster by superimposing a caption signal in an active period of a broadcasting signal, and a closed caption system for displaying a caption of words on the screen by selection of a viewer by encoding the caption signal in a non-active period, i.e., in a vertical blanking period of the broadcasting signal.

In the closed caption system, when recording a video signal on a recording medium, the caption signal is encoded in a desired position of the video signal and then recorded on the recording medium such as a magnetic tape and an optical recording medium. The caption signal in the closed caption system generally displays a caption corresponding to an audio signal output through a speaker.

FIG. 1 is a block diagram of a conventional system for retrieving information having a caption function. As shown in FIG. 1, the conventional system for retrieving information comprises a recording medium reproducing portion 1 for reproducing a recording medium on which video data including caption information is recorded, a memory 2 for storing the caption information according to key input by a user, a key input panel 3 for selecting a caption mode and inputting an instruction of storing the caption information by the user, a web browser providing portion 4 for performing Internet retrieval of a corresponding word selected from the caption information in the memory 2 by the user, a displaying portion 5 for displaying the video and the caption reproduced by selection of a caption mode by the user, and a controlling portion 6 for controlling an operation of the recording medium reproducing portion 1, the memory 2, the web browser-providing portion 4 and the displaying portion 5 according to an input signal through the key input panel 3.

In an information retrieving operation of the conventional retrieving system using the caption information, as described above, first, if the user inputs a caption information-storing signal and a caption mode-selecting signal using the key input panel 3, images and characters corresponding to the caption information are displayed on the displaying portion 5 and, at the same time, the caption information is stored in the memory 2. The controlling portion 6 determines whether broadcast viewing is terminated according to selection of the user. Then, if it is determined that the broadcast viewing is terminated, the controlling portion 6 determines whether there is an instruction for displaying the caption information stored in the memory 2 by the key input panel 3. If it is determined that the instruction exists, the controlling portion 6 displays the caption information stored in the memory 2 through the displaying portion 5. If the user selects a specific word out of the characters corresponding to the caption information displayed through the displaying portion 5, the web browser-providing portion 4 performs an Internet retrieving operation for the selected word. The controlling portion 6 displays a result retrieved from the web browser-providing portion 4 on the displaying portion 5.

However, in the conventional information retrieving system for the caption information, there is a disadvantage that the user has to perform an key inputting operation several times through the key input panel 3 in order to perform the retrieving operation for the caption information displayed on a broadcast that the user is viewing.

Further, in the conventional information retrieving system using the caption information, the user has to store the caption information according to selection of a caption mode in the memory 2 and then to terminate the broadcast viewing in order to perform the retrieving operation from the caption information. After that, the user has to withdraw the caption information stored in the memory 2 and then to display the information on the displaying portion 5. Therefore, mutual interlockability between the broadcast viewing and the information retrieving is lowered.

In addition, in order to perform the information retrieving operation through the web browser-providing portion 4, the user has to directly designate the specific word from the characters displayed on the displaying portion 5. Therefore, there is a problem that the information retrieving operation is passively performed.

### SUMMARY OF THE INVENTION

Therefore, it is an object of the present invention to provide a system for retrieving information using caption information, which is capable of facilely performing an information retrieving operation by a simple key selecting operation of a user, when retrieving the information on the Internet, which is related to a broadcast that the user is viewing, using the caption information received from a broadcasting signal and a reproduced signal from a recording medium.

It is another object of the present invention to provide a system for retrieving information using caption information, in which the retrieving operation for the caption information received during the broadcast viewing is performed at the same time so that the broadcast viewing operation is mutually interlocked with the information retrieving operation.

It is another object of the present invention to provide a system for retrieving information using caption information, which is capable of performing the information retrieving operation according to an information retrieving instruction of the user.

To achieve the aforementioned objects of the present invention, a system for retrieving information by one click using caption information according to the present invention comprises a broadcasting signal receiving portion for receiving a broadcasting signal including the caption information, a caption information storing portion for storing the caption information received during a desired time period on the basis of the time point that a user inputs an information retrieving instruction for the caption information, and an Internet retrieving portion for performing an Internet retrieving operation using at least one word of the caption information received during TV watching of the user.

Preferably, the system further comprises a sentence analyzing portion for separating a main word from the caption information stored in the caption information storing portion, wherein the Internet retrieving portion performs an Internet retrieving operation for the main word. Further, the system further comprises a displaying portion for displaying a retrieved result of the Internet retrieving portion on a desired portion of a screen on which the broadcasting signal is displayed, an input portion for inputting an instruction for displaying the retrieved result of the Internet retrieving portion on the screen, and a retrieved result storing portion for storing the retrieved result of the Internet retrieving portion.

In addition, to achieve the aforementioned objects of the present invention, a method for retrieving information by one click using caption information comprises steps of receiving an instruction for retrieving the caption information from a broadcasting signal including the caption information, storing the caption information received during a desired time period on the basis of a time portion that the instruction is received, and performing an Internet retrieving operation during TV watching of a user using at least one word of the caption information as a key word.

Preferably, the method further comprises a step of separating a main word from the caption information stored in the caption information storing step, after the caption information storing step, wherein an operation of retrieving the main word is performed in the Internet retrieving step.

Further, the method further comprises a step of displaying a result retrieved in the Internet retrieving step on a desired portion of a screen on which the broadcasting signal is displayed, after the Internet retrieving step. Meanwhile, the method further comprises a step of inputting an instruction for displaying the retrieved result on the screen, before the displaying step, and a step of storing the result retrieved in the Internet retrieving step, after the Internet retrieving step.

According to the present invention, in the operation of retrieving information on the Internet, which is related to the broadcast that the user is viewing, using the caption information included in the received broadcasting signal, if the user inputs the information retrieving instruction through the input portion, the caption information retrieving portion performs the information retrieving operation for the received caption information, thereby simply performing the information retrieving operation for the caption information. Further, the information retrieving operation for the caption information received while the user is viewing is performed at the same time, thereby mutually interlocking the broadcast viewing and the information retrieving.

### BRIEF DESCRIPTION OF THE DRAWINGS

The above objects and other advantages of the present invention will become more apparent by describing in detail preferred embodiments thereof with reference to the attached drawings in which:

FIG. 1 is a block diagram of a conventional system for retrieving information with a caption function;

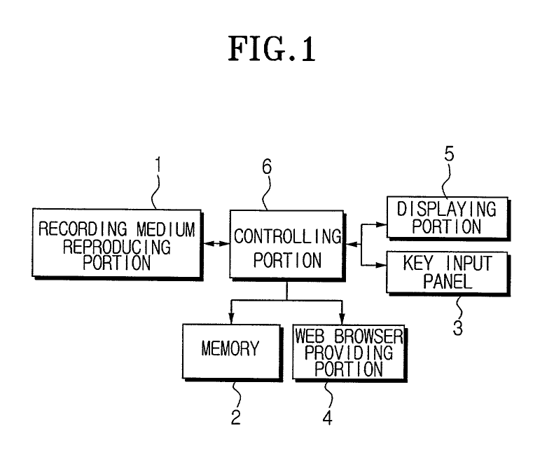

FIG. 2 is a block diagram of a system for retrieving information using caption information according to an embodiment of the present invention; and

FIG. 3 is a flow chart of a method for retrieving information using the caption information according to the present invention.

### DETAILED DESCRIPTION OF THE PREFERRED EMBODIMENTS

Now, preferred embodiments of the present invention will be described in detail with reference to the annexed drawings.

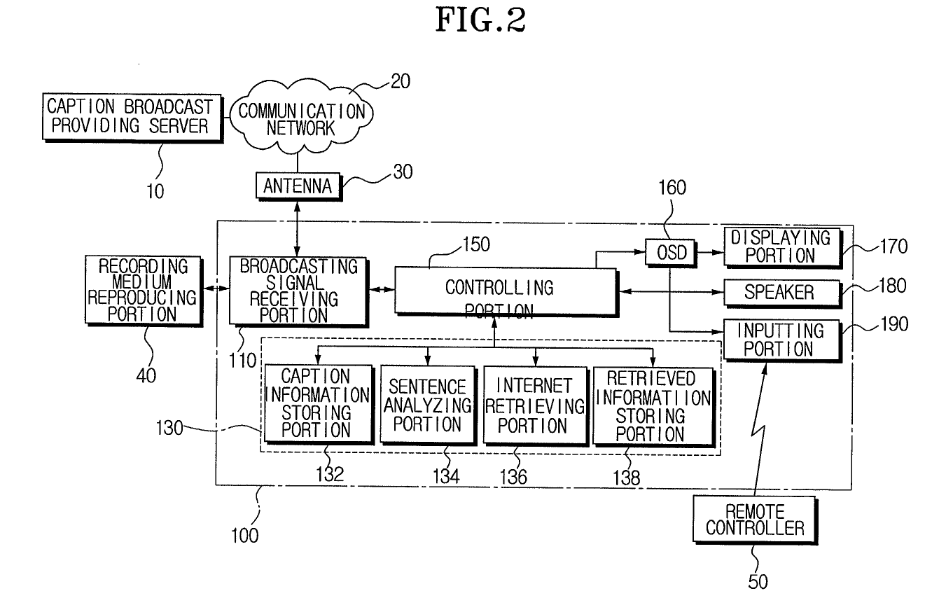

FIG. 2 is a block diagram of a system for retrieving information by one click, using caption information, according to an embodiment of the present invention. Referring to the drawing, a system 100 for retrieving information according to an embodiment of the present invention comprises a broadcasting signal receiving portion 110 for receiving a broadcasting signal including caption information, a caption information retrieving portion 130 for performing an information retrieving operation through Internet from the received caption information, a displaying portion 170 for displaying a result retrieved from the caption information retrieving portion 130, an input portion 190 for inputting an instruction for displaying the result retrieved from the caption information retrieving portion 130 and a controlling portion 150 for controlling an operation of the broadcasting signal receiving portion 110 and an operation of the caption information retrieving portion 130 and the displaying portion 170 according to a signal input from the input portion 190.

The broadcasting signal receiving portion 110 receives a broadcasting signal from a recording medium reproducing portion 40 for reproducing the broadcasting signal recorded on the recording medium, and a caption broadcast providing server 10 for providing a caption broadcast. The broadcasting signal from the caption broadcast providing server 10 is transmitted through a wire and wireless communication network 20 and a wire and wireless antenna 30 to the broadcasting signal receiving portion 110. The broadcasting signal receiving portion 110 separates video, audio and the caption information from the received broadcasting signal and then outputs to the controlling portion 150.

The controlling portion 150 displays the video on the displaying portion 170 and also outputs the audio through a speaker 180. At this time, if the user selects a caption mode using a remote controller 50 or the input portion 190, the controlling portion 150 controls an OSD (on screen display) 160 for performing a function of displaying the characters corresponding to the caption information on the displayed video so that the video and the characters are displayed on a desired portion of the displaying portion 170. If the user inputs the information retrieving instruction for the caption information during receiving of the caption broadcast using the input portion 190, the controlling portion 150 outputs the input information retrieving instruction to the caption information-retrieving portion 130.

The caption information retrieving portion 130 comprises a caption information storing portion 132 for storing the caption information received in the broadcasting signal receiving portion 110 during a desired time period on the basis of a time point that the information retrieving instruction for the caption information is input from the controlling portion 150, a sentence analyzing portion 134 for separating a main word from the caption information stored in the caption information storing portion 132, an Internet retrieving portion 136 for performing the Internet retrieving operation for the caption information stored in the caption information storing portion 132, and a retrieved information storing portion 138 for storing a result retrieved from the Internet retrieving portion 136.

Therefore, in the operation of retrieving information on the Internet, which is related to the broadcast that the user is viewing, using the caption information included in the broadcasting signal, if the user inputs the information retrieving instruction through the input portion 190, the caption information retrieving portion 130 performs the information retrieving operation for the received caption information. Accordingly, the information retrieving operation for the caption information can be facilely performed by only a simple inputting operation of the information retrieving instruction by the user. Moreover, the caption information retrieving portion 130 extracts the main word of the received caption information according to the inputting of the information retrieving instruction by the user, and then performs the information retrieving operation using the extracted main word as the key word, thereby actively performing the information retrieving operation for the caption information.

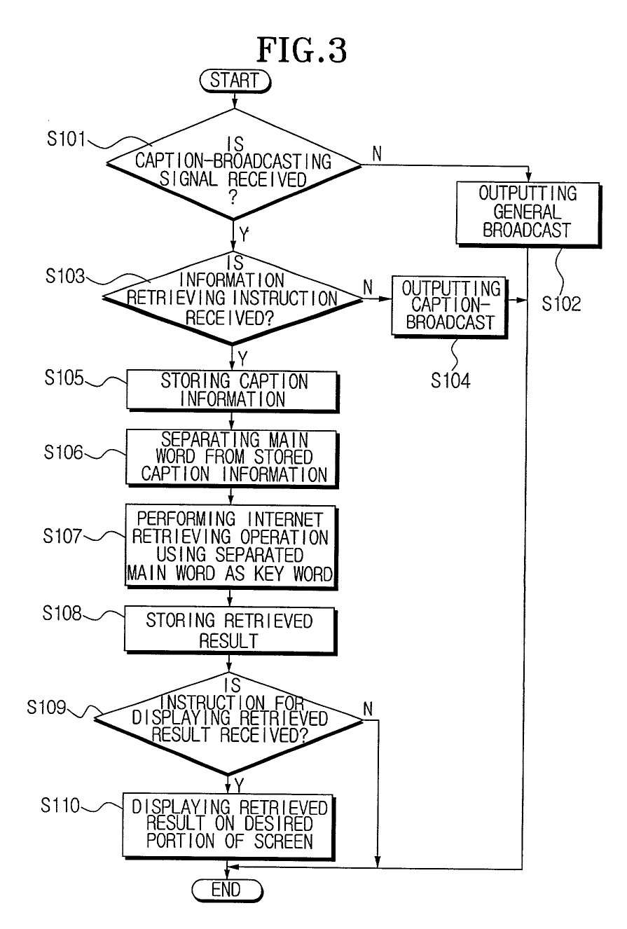

FIG. 3 is a flow chart of a method of retrieving information using the caption information according to the present invention. Referring to the drawing, first, the controlling portion 150 determines whether the broadcasting signal that the user is viewing is a caption-broadcasting signal (S101). In the step 101, if it is determined that the broadcasting signal is not the caption-broadcasting signal but a general broadcasting signal, the controlling portion 150 reproduces the video and audio of the general broadcasting signal and then outputs to the displaying portion 170 and the speaker 180 (S102). In the step 101, if it is determined that the broadcasting signal is the caption-broadcasting signal, the controlling portion 150 determines whether the information retrieving instruction for the caption information is input from the input portion 190 (S103). In the step 103, if it is determined that the information retrieving instruction for the caption information is not input, the controlling portion 150 outputs the video, the audio and the characters of the caption information to the displaying portion 170 and the speaker 180 (S104).

In the step 103, if it is determined that the information retrieving instruction for the caption information is input, the controlling portion 150 stores the caption information received during the desired time period on the basis of the time point that the information retrieving instruction is input (S105). The sentence-analyzing portion 134 separates the main word from the caption information stored in the caption information storing portion 132 (S106). The Internet retrieving portion 136 retrieves related information through a communication network such as the Internet, etc., using the main word as the key word (S107). The controlling portion 150 stores the retrieved result in the retrieved information storing portion 138 (S108).

The controlling portion 150 determines whether an instruction for displaying the retrieved result stored in the retrieved information storing portion 138 is input through the input portion 190 (S109). If the instruction for displaying the retrieved result is input, the controlling portion 150 outputs the caption broadcast to the displaying portion 170 and the speaker 180 and, at the same time, displays the retrieved result stored in the retrieved information storing portion 138 on the displaying portion using the OSD function (S10).

Accordingly, the information retrieving operation for the caption information received while the user is viewing is performed at the same time, thereby mutually interlocking the broadcast viewing and the information retrieving. Further, the caption information retrieving portion 130 extracts the main word of the caption information according to the inputting of the information retrieving instruction by the user, and then performs the information retrieving operation using the extracted main word as the key word, thereby actively performing the information retrieving operation for the caption information.

According to the present invention, in the operation of retrieving information on the Internet, which is related to the broadcast that the user is viewing, using the caption information included in the received broadcasting signal, if the user inputs the information retrieving instruction through the input portion 190, the caption information retrieving portion 130 performs the information retrieving operation for the received caption information, thereby simply performing the information retrieving operation for the caption information.

While the present invention has been described in detail, it should be understood that various changes, substitutions and alterations could be made hereto without departing from the spirit and scope of the invention as defined by the appended claims.

What is claimed is:

1. A system for retrieving information by one click using caption information, comprising:
a broadcasting signal receiving portion for receiving a broadcasting signal including the caption information;
a caption information storing portion for storing the caption information received during a desired time period on the basis of a time point when a user inputs an information retrieving instruction for the caption information; and
an Internet retrieving portion for performing an Internet retrieving operation using at least one word of the caption information.

2. The system of claim 1, further comprising a sentence analyzing portion for separating a main word from the caption information stored in the caption information storing portion.

3. The system of claim 2, further comprising a displaying portion for displaying a retrieved result of the Internet retrieving portion on a desired portion of a screen on which the broadcasting signal is displayed.

4. The system of claim 3, further comprising an input portion for inputting an instruction for displaying the retrieved result of the Internet retrieving portion on the screen.

5. The system of claim 4, further comprising a retrieved result storing portion for storing the retrieved result of the Internet retrieving portion.

6. A method for retrieving information by one click using caption information, comprising the steps of:
receiving an instruction for retrieving the caption information from a broadcasting signal including the caption information;
storing the caption information received during a desired time period on the basis of a time portion that the instruction is received; and
performing an Internet retrieving operation during TV watching of a user using at least one word of the caption information as a key word.

7. The method of claim 6, further comprising a step of separating a main word from the caption information stored in the caption information storing step, after the caption information storing step,
wherein an operation of retrieving using the main word is performed in the Internet retrieving step.

8. The method of claim 7, further comprising a step of displaying a result retrieved in the Internet retrieving step on a desired portion of a screen on which the broadcasting signal is displayed, after the Internet retrieving step.

9. The method of claim 8, further comprising a step of inputting an instruction for displaying the retrieved result on the screen, before the displaying step.

10. The method of claim 9, further comprising a step of storing the result retrieved in the Internet retrieving step, after the Internet retrieving step.
